(19) United States
(12) Patent Application Publication
(10) Pub. No.: US 2014/0062429 A1
(43) Pub. Date: Mar. 6, 2014

(54) RECTIFIER CIRCUIT

(71) Applicant: SK HYNIX INC., Icheon-si (KR)

(72) Inventor: Sung Wook CHOI, Icheon-si (KR)

(73) Assignee: SK HYNIX INC., Icheon-si (KR)

(21) Appl. No.: 13/846,509

(22) Filed: Mar. 18, 2013

(30) Foreign Application Priority Data
Sep. 4, 2012 (KR) 10-2012-0097783

(51) Int. Cl. H02M 3/02

(52) U.S. Cl. CPC H02M 3/02
USPC 323/234

(57) ABSTRACT

A rectifier circuit capable of attenuating an offset voltage wherein the rectifier circuit includes an amplification unit configured to generate an output voltage through an output terminal in response to a reference voltage and a voltage at a feedback node, a plurality of first unit resistors connected between the output terminal and the feedback node, and a plurality of second unit resistors connected between the feedback node and a ground terminal, and wherein each of the first unit resistors and each of the second unit resistors are designed to have different resistance values.

### CROSS-REFERENCES TO RELATED APPLICATION

The present application claims priority under 35 U.S.C. §119(a) to Korean application number 10-2012-0097783, filed on Sep. 4, 2012, in the Korean Intellectual Property Office, which is incorporated herein by reference in its entirety.

### BACKGROUND

1. Technical Field

The present invention generally relates to a semiconductor circuit, and more particularly, to a rectifier circuit.

2. Related Art

A known rectifier circuit used in a semiconductor circuit can be configured by in series coupling an operational amplifier and unit resistors having the same resistance value. Furthermore, a large number of the unit resistors must be used in order to improve the resolution of the rectifier circuit.

The known rectifier circuit is problematic in that an error in an output level is increased due to the finite open loop gain of the operational amplifier when a plurality of unit resistors having the same resistance value is used.

For example, if a reference voltage of 1.25 V and a unit resistance of 8 K are used, a severe voltage drop of 600 mV, that is, an offset voltage, is generated on the basis of a target voltage of 27 V.

The offset voltage is inevitably generated because an operational amplifier having an ideally infinite gain cannot exist, and the value of the offset voltage is not regular and is linearly increased depending on a level.

### SUMMARY

A rectifier circuit capable of attenuating an offset voltage is described herein.

In an embodiment, a rectifier circuit includes an amplification unit configured to generate an output voltage through an output terminal in response to a reference voltage and a voltage at a feedback node and a feedback unit configured to feed voltage, obtained by dividing the output voltage in a set division ratio, back to the amplification unit through the feedback node, wherein the feedback unit can vary the gain of the amplification unit so that the gain corresponds to a change of the output voltage.

In an embodiment, a rectifier circuit includes an amplification unit configured to generate an output voltage through an output terminal in response to a reference voltage and a voltage at a feedback node, a plurality of first unit resistors connected between the output terminal and the feedback node, and a plurality of second unit resistors connected between the feedback node and a ground terminal, wherein each of the first unit resistors and each of the second unit resistors can be designed to have different resistance values.

### BRIEF DESCRIPTION OF THE DRAWINGS

Features, aspects, and embodiments are described in conjunction with the attached drawings, in which:

FIG. 1 is a circuit diagram of a rectifier circuit 100 in accordance with an embodiment; and

FIG. 2 is a detailed circuit diagram of a feedback unit 300 of FIG. 1.

### DETAILED DESCRIPTION

Hereinafter, a rectifier circuit according to the various embodiments will be described below with reference to the accompanying drawings through the embodiments.

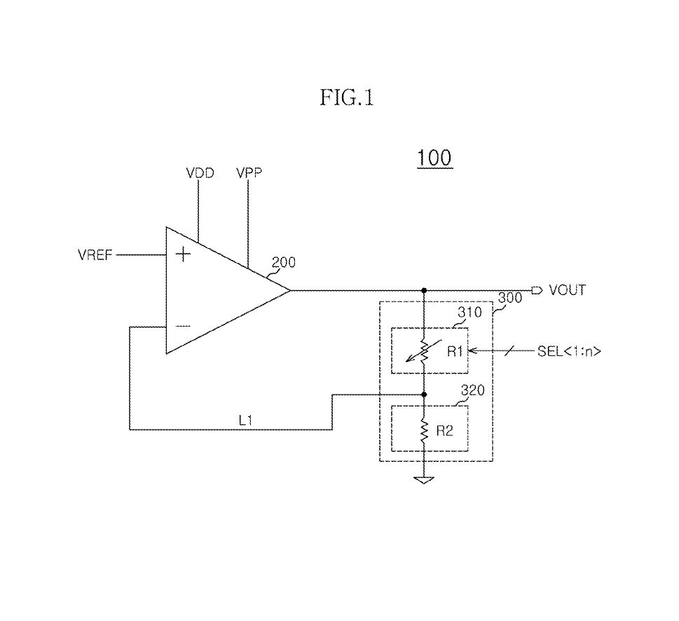

FIG. 1 is a circuit diagram of a rectifier circuit 100 in accordance with an embodiment.

As shown in FIG. 1, the rectifier circuit 100 in accordance with an embodiment may include an amplification unit 200 and a feedback unit 300.

The amplification unit 200 may be configured to generate an output voltage VOUT through an output terminal thereof in response to a reference voltage VREF and voltage at a feedback node L1.

The amplification unit 200 may be formed of an operational amplifier.

The amplification unit 200 may receive a first power source voltage VDD for operating the circuit and a second power source voltage VPP for generating the output voltage VOUT.

The reference voltage VREF may be inputted to the non-inverting terminal (+) of the amplification unit 200, and the voltage at the feedback node L1 may be inputted to the inverting terminal (−) of the amplification unit 200.

The amplification unit 200 may control an output current so that the voltage of the feedback node L1 has the same level or substantially the same level as the reference voltage VREF in order to maintain the output voltage VOUT in a target level.

The feedback unit 300 may be configured to feed a division voltage, obtained by dividing the output voltage VOUT in a set division ratio, back to the amplification unit 200 through the feedback node L1.

The feedback unit 300 may include a first resistor array 310 connected between the output terminal of the amplification unit 200 and the feedback node L1 and a second resistor array 320 connected between the feedback node L1 and a ground terminal.

The first resistor array 310 may have a resistance value R1 that varies in response to selection signals SEL<1:n>.

The selection signals SEL<1:n> can be supplied by a fuse set and a mode register set.

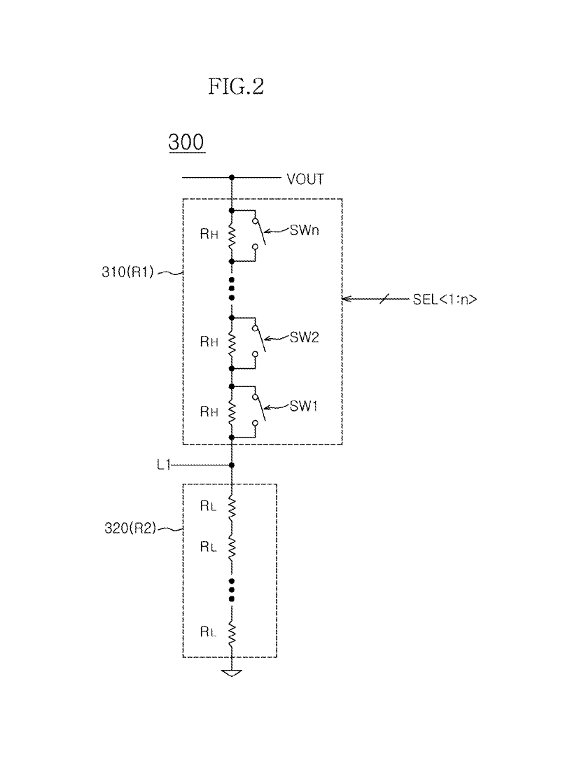

FIG. 2 is a detailed circuit diagram of the feedback unit 300 of FIG. 1.

As shown in FIG. 2, the first resistor array 310 of the feedback unit 300 may include a plurality of first unit resistors R_{H} coupled in series between the output terminal (i.e., where VOUT may be obtained) and the feedback node L1.

Each of a plurality of switches SW1˜SWn may be connected across each of the plurality of first unit resistors R_{H}.

The plurality of switches SW1˜SWn may selectively operate in response to the respective selection signals SEL<1:n>and vary the resistance value of the first resistor array 310 (i.e., 310(R1)) by controlling the number of first unit resistors R_{H} through which respective currents flow.

The second resistor array 320 (i.e., 320(R2)) of the feedback unit 300 may include a plurality of second unit resistors R_{L} coupled in series between the feedback node L1 and the ground terminal.

The first unit resistor R_{H} and the second unit resistor R_{L} may be designed to have different values.

For example, the first unit resistor R_{H} can be designed to have a higher resistance value than the second unit resistor R_{L}.

A ratio of the resistance value of the second unit resistor R_{L} to the resistance value of the first unit resistor R_{H} can be determined by taking a variety of operating characteristics, such as an offset characteristic, into consideration.

In the rectifier circuit 100 in accordance with an embodiment, the first unit resistor R_{H} may be designed to have a higher resistance value than the second unit resistor R_{L}. Accordingly the output voltage VOUT may maintain a target level because the offset voltage of the amplification unit 200 is compensated for.

The offset voltage compensation principle of the rectifier circuit 100 in accordance with an embodiment is described below.

First, the rectifier circuit 100 in accordance with an embodiment may be configured to control the amount of current that flows through the second resistor array 320 and to generate the output voltage VOUT using a voltage drop in the first resistor array 310.

The amount of current flowing through the second resistor array 320 may be controlled by virtually shorting the voltage of the feedback node L1, inputted to the inverting terminal of the amplification unit 200, and the reference voltage VREF inputted to the non-inverting terminal.

The amplification unit 200 cannot have an infinite gain. If, as in the prior art, both the first resistor array 310 and the second resistor array 320 are formed of the unit resistors having the same resistance value, the voltage of the feedback node L1 becomes lower than the reference voltage VREF although the output voltage VOUT has substantially the same value as the target level. The offset voltage generates an offset current, and the offset voltage is further increased according to an increase of the target level of the output voltage VOUT.

Thus, in an embodiment, the first unit resistor R_{H} may designed to have a higher resistance value than the second unit resistor R_{L}. Accordingly, the resistance value of the first unit resistor R_{H} may be linearly increased according to an increase in the target level of the output voltage VOUT.

Here, the voltage of the feedback node L1 is ‘VREF−VOUT/AOL’.

The AOL is the open loop gain of the amplification unit 200.

In an embodiment, the first unit resistor R_{H} may be designed to have a higher resistance value than the second unit resistor R_{L}. Accordingly, the resistance value of the first unit resistor R_{H} may be linearly increased according to the target level of the output voltage VOUT.

When the target level of the output voltage VOUT rises, the open loop gain AOL also rises because the resistance value is linearly increased and thus the output voltage VOUT is increased.

When the output voltage VOUT rises, the open loop gain AOL is also increased. Accordingly, the voltage of the feedback node L1 can be substantially maintained regularly although the output voltage VOUT increases.

Here, I=L1 voltage/R2.

I is an electric current that flows through both the first resistor array 310 and the second resistor array 320, and R2 is the resistance value of the second resistor array 320.

Since the L1 voltage remains constant and R2 has a fixed value, an electric current I flowing through both the first resistor array 310 and the second resistor array 320 remains constant.

As a result, in an embodiment, the first unit resistor R_{H} is designed to have a higher resistance value than the second unit resistor R_{L}. Accordingly, the output voltage VOUT can be maintained to a desired level by compensating for an offset voltage generated due to the characteristics of the amplification unit 200, that is, characteristic having a finite gain.

These embodiments can improve the operation performance of the rectifier circuit by attenuating the offset voltage.

While various embodiments have been described above, it will be understood to those skilled in the art that the embodiments described are by way of example only. Accordingly, the rectifier circuit described herein should not be limited based on the described embodiments.

What is claimed is:

1. A rectifier circuit, comprising:
an amplification unit configured to generate an output voltage through an output terminal in response to a reference voltage and a voltage at a feedback node; and
a feedback unit configured to feed voltage, obtained by dividing the output voltage in a set division ratio, back to the amplification unit through the feedback node,
wherein the feedback unit varies a gain of the amplification unit so that the gain corresponds to a change of the output voltage.

2. The rectifier circuit according to claim 1, wherein the feedback unit comprises:
is a first resistor array connected between the output terminal and the feedback node, and
a second resistor array connected between the feedback node and a ground terminal.

3. The rectifier circuit according to claim 2, wherein the first resistor array is configured to have a resistance value varying in response to selection signals.

4. The rectifier circuit according to claim 2, wherein the first resistor array is configured for linearly increasing the resistance value of the first resistor array according to a target level of the output voltage.

5. The rectifier circuit according to claim 2, wherein an open loop gain of the amplification unit rises as the output voltage of the output terminal rises.

6. The rectifier circuit according to claim 3, wherein the selection signals are supplied by a fuse set and a mode register set.

7. The rectifier circuit according to claim 2, wherein the first resistor array comprises:
a plurality of unit resistors coupled in series, and a plurality of switches each coupled across each of the plurality of unit resistors and configured to be controlled in response to the selection signals.

8. The rectifier circuit according to claim 2, wherein the second resistor array comprises a plurality of unit resistors coupled in series.

9. The rectifier circuit according to claim 2, wherein:
each of the first resistor array and the second resistor array comprises a plurality of unit resistors, and
the unit resistor of the first resistor array and the unit resistor of the second resistor array have different resistance values.

10. The rectifier circuit according to claim 2, wherein:
each of the first resistor array and the second resistor array comprises a plurality of unit resistors, and
each of the unit resistors of the first resistor array is designed to have a higher resistance value than each of the unit resistors of the second resistor array.

11. The rectifier circuit according to claim 1, wherein the amplification unit comprises an operational amplifier.

12. A rectifier circuit, comprising:
an amplification unit configured to generate an output voltage through an output terminal in response to a reference voltage and a voltage at a feedback node;
a plurality of first unit resistors connected between the output terminal and the feedback node; and
a plurality of second unit resistors connected between the feedback node and a ground terminal,
wherein each of the first unit resistors and each of the second unit resistors are designed to have different resistance values.

13. The rectifier circuit according to claim 12, wherein the amplification unit receives the reference voltage though a non-inverting terminal and the voltage of the feedback node through an inverting terminal.

14. The rectifier circuit according to claim 12, wherein the first unit resistor is designed to have a higher resistance value than the second unit resistor.

15. The rectifier circuit according to claim 12, wherein the plurality of first unit resistors is designed to have substantially an identical resistance value.

16. The rectifier circuit according to claim 15, wherein the plurality of second unit resistors is designed to have substantially an identical resistance value.

17. The rectifier circuit according to claim 16, wherein the first unit resistor is designed to have a higher resistance value than the second unit resistor.
